(19) United States
(12) Patent Application Publication
(10) Pub. No.: US 2026/0094124 A1
(43) Pub. Date: Apr. 2, 2026

(54) Generative Model for Generating Personalized Newsletters for a Publisher

(71) Applicant: Google LLC, Mountain View, CA (US)

(72) Inventors: Justin Lewis Kosslyn, New York, NY (US); Mathias Jean René Sallé, San Francisco, CA (US); Idan Avraham, Tel Aviv (IL); Ziv Hodak, Tel Aviv (IL)

(21) Appl. No.: 18/900,058

(22) Filed: Sep. 27, 2024

(51) Int. Cl. G06Q 10/107; G06F 16/335; G06F 16/34

(52) U.S. Cl. CPC G06Q 10/107; G06F 16/337; G06F 16/345

(57) ABSTRACT

Systems and methods for generating a personalized newsletter. The system can include a database storing a plurality of content items and a machine-learned model that is configured to generate the personalized newsletter. The system can process a plurality of content items of a publisher to generate an attribute for each content item in the plurality of content items. Additionally, the system can select, based on the attribute for each content item in the plurality of content items, a subset of content items from the plurality of content items. Moreover, the system can process the subset of content items, using the machine-learned model, to generate a summary. Furthermore, the system can generate a newsletter based on the summary and the subset of content items.

### FIELD

The present disclosure relates generally to utilizing a generative model to generate a personalized newsletter. More particularly, the present disclosure relates to using a generative model to generate model-generated content items for a personalized newsletter.

### BACKGROUND

A newsletter offers several benefits for publishers and their audience (e.g., subscribers, readers, listeners), particularly when it comes to communication and engagement. The newsletter allows a publisher to regularly share news, updates, business campaigns, and information directly with their audience. The newsletter can include links to blog posts, articles, or products, which can drive traffic to a publisher's website or e-commerce platform. The newsletter can also include banners for active business campaigns, such as seasonal solicitations for reader donations to support the publication. The newsletter can help maintain engagement with existing audiences by providing valuable content. Through ongoing communication and relationship-building, the newsletter can help reduce customer churn and maintain long-term engagement. A well-executed newsletter helps build relationships, foster loyalty, and drive results for publishers. The newsletter provides a direct and personalized communication channel that boosts brand awareness, engagement, revenue, and conversions.

Large language models can be utilized for realistic generation of a natural language content, which can be trained on large training datasets including diverse language instances. However, the generated language outputs may fail to meet publisher-specific requirements, which may cause issues with readability, reliability, trust, and/or other quality metrics. Additionally, large language models may generate hallucinations that may include fabricated facts and/or sources.

Specific fields of expertise can have different structures, terminology, and/or other attributes. The different domains may differ in style, length, syntax, vocabulary, and/or other features. Creation of newsletters within the different domains can be time consuming, require a level of expertise, and/or labor intensive.

### SUMMARY

Aspects and advantages of embodiments of the present disclosure will be set forth in part in the following description, or can be learned from the description, or can be learned through practice of the embodiments.

One example aspect of the present disclosure is directed to a computing system for generating a newsletter. The system can include a database storing a plurality of content items (e.g., articles) and a machine-learned model that is configured to generate the newsletter. The system can include one or more processors and one or more non-transitory computer-readable media that collectively store instructions that, when executed by the one or more processors, cause the computing system to perform operations. The operations can include processing the plurality of content items to generate an attribute for each content item in the plurality of content items. Additionally, the operations can include selecting, based on the attribute for each content item in the plurality of content items, a subset of content items from the plurality of content items. Moreover, the operations can include processing the subset of content items, using the machine-learned model, to generate a summary (e.g., an editorial summary). Furthermore, the operations can include generating a newsletter based on the editorial summary and the subset of content items.

In some instances, the operations can further include obtaining weather data associated with a location of a specific user. Additionally, the operations can include processing, using the machine-learned model, the weather data and the subset of content items to generate the editorial summary, wherein the newsletter is personalized for the specific user.

In some instances, the operations can further include determining trend data based on interest of similar users. Additionally, the operations can include processing, using the machine-learned model, the trend data, the editorial summary, and the subset of content items to generate the newsletter.

In some instances, the operations can further include determining a voice of the publisher, the voice of the publisher having a specific tone. Additionally, the operations can include processing, using the machine-learned model, the voice of the publisher, the editorial summary, and the subset of content items to generate the newsletter.

In some instances, the plurality of content items can be processed by the machine-learned model to generate a plurality of attributes for each content item in the plurality of content items.

In some instances, the selecting of the subset of content items from the plurality of content items can include determining a relevance score for each content item in the plurality of content items based on the plurality of attributes for each content item in the plurality of content items. Additionally, the operations can include ranking each content item in the plurality of content items based on the relevance score for each content item, and wherein the subset of content items are selected based on the ranking of each content item.

In some instances, the attribute can be a relevance score for a specific topic.

In some instances, the attribute can be a relevance score for a specific group of users.

In some instances, the attribute can be associated with a topic.

In some instances, the attribute can be associated with a publication date.

In some instances, the database can include a plurality of newsletter templates. Additionally, the operations can include selecting, based on the subset of content items, a first template from the plurality of newsletter template, and wherein the newsletter is generated using the selected template.

In some instances, the operations can include obtaining user data associated with a first user. Additionally, the operations can include selecting the subset of content items from the plurality of content items based on the user data. Moreover, the operations can include processing the subset of content items and the user data, using the machine-learned model, to generate the editorial summary. Furthermore, the operations can include generating the newsletter using the editorial summary, the subset of content items, and the user data. Subsequently, the operations can include transmitting the newsletter to an email account associated with the first user.

In some instances, the newsletter can be transmitted at a first time interval, and wherein the first time interval is based on the user data.

In some instances, the operations can include obtaining group data associated with a first group of users. Additionally, the operations can include selecting the subset of content items from the plurality of content items based on the group data. Moreover, the operations can include determining a first template for the newsletter based on the group data. Furthermore, the operations can include generating the newsletter for the first group of users using the first template.

In some instances, the first template can have a content plan that is determined based on the group data. Additionally, the first template can have a content structure that is determined based on the group data.

In some instances, the operations can further include fetching a first content item from a server of the publisher. For example, the system can crawl a server to obtain content items associated with the publisher. In another example, the publisher can send (e.g., using a RSS feed) content items to the system. Additionally, the operations can include determining that the first content item is a non-sponsored content item. Moreover, the operations can include storing the first content item in the database to be included in the plurality of content items.

In some instances, the operations can further include receiving user input associated with a selected content item in the newsletter. Additionally, the operations can include updating a parameter of the machine-learned model, based on the user input.

In some instances, the operations can further include generating an updated newsletter. The updated newsletter can be generated based on the user input associated with the selected content item.

Another example aspect of the present disclosure is directed to a computer-implemented method. The method can include obtaining, by a computing system comprising one or more processors, a plurality of content items, the plurality of content items being associated with a publisher. Additionally, the method can include processing the plurality of content items to generate an attribute for each content item in the plurality of content items. Moreover, the method can include selecting, based on the attribute for each content item in the plurality of content items, a subset of content items from the plurality of content items. Furthermore, the method can include processing the subset of content items, using the machine-learned model, to generate an editorial summary. Subsequently, the method can include generating a newsletter based on the editorial summary and the subset of content items.

Another example aspect of the present disclosure is directed to one or more non-transitory computer-readable media that collectively store instructions that, when executed by one or more computing devices, cause the one or more computing devices to perform operations. The operations can include obtaining a plurality of content items, the plurality of content items being associated with a publisher. The operations can include processing the plurality of content items to generate an attribute for each content item in the plurality of content items. Additionally, the operations can include selecting, based on the attribute for each content item in the plurality of content items, a subset of content items from the plurality of content items. Moreover, the operations can include processing the subset of content items, using the machine-learned model, to generate an editorial summary. Furthermore, the system can include generating a newsletter based on the editorial summary and the subset of content items.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example publisher-specific tuning system according to example embodiments of the present disclosure.

FIG. 2 depicts a flow chart diagram of an example method to perform generative model tuning according to example embodiments of the present disclosure.

FIG. 3 depicts an illustration of an example news article structure according to example embodiments of the present disclosure.

FIG. 4 depicts a flow chart diagram of an example method to generate a newsletter according to example embodiments of the present disclosure.

FIG. 5 depicts an illustration of an example email according to example embodiments of the present disclosure.

FIG. 6 depicts an illustration of an example newsletter according to example embodiments of the present disclosure.

FIG. 7 depicts a block diagram of an example candidate model-generated content item selection system according to example embodiments of the present disclosure.

FIG. 8 depicts a block diagram of an example infrastructure system according to example embodiments of the present disclosure.

FIG. 9A depicts a block diagram of an example computing system that performs publisher-specific content item generation according to example embodiments of the present disclosure.

FIG. 9B depicts a block diagram of an example computing system that performs publisher-specific content item generation according to example embodiments of the present disclosure.

FIG. 9C depicts a block diagram of an example computing system that performs publisher-specific content item generation according to example embodiments of the present disclosure.

Reference numerals that are repeated across plural figures are intended to identify the same features in various implementations.

### DETAILED DESCRIPTION

Generally, the present disclosure is directed to systems and methods for generating a newsletter for a publisher using a machine-learned model to generate model-generated content. The system having a machine-learned model can generate a plurality of personalized newsletter for a publisher based on a determined objective and a target audience. Additionally, the system can utilize newsletter templates, automation processes, and analytics to improve the effectiveness of each newsletter for a target audience.

In some instances, the system generates the different sections of the newsletter based on input data. The different sections can include an editorial summary of a list of featured content items. Content items can include articles, audio recordings (e.g., podcasts), video recording, highlights, interviews, events, announcements, promotions, offers, images, links, buttons, and other content that is generated by the publisher. The system can determine a frequency (e.g., daily, weekly, biweekly, or monthly) for sending the newsletter to a targeted audience. Additionally, the system can personalize the design of the newsletter depending on the target audience.

In some instances, the system can customize the newsletter with a plurality of tone and style based on the brand of the publisher, the selected content items (e.g., articles), and the targeted audience. For example, the tone can be casual and friendly or formal and professional, depending on the publisher's brand. Additionally, the design can be generated depending on the device type (e.g., desktop and mobile devices).

In some instances, the system can obtain analytics data associated with the personalized newsletter. The system can train and/or fine-tune the machine learned model based on the analytics data. The analytics data can include an open rate (e.g., percentage of recipients who opened the email), a click-through rate (e.g., recipients who clicked on links within the email), and other performance metrics.

According to some embodiments, an effective periodic (e.g., daily, weekly) newsletter can be similar to a second homepage for a news publisher. In some instances, the newsletter can fulfill the same structural function as being the gateway to the content of the publisher. For example, in the same way that a user can go to a home page and then choose which articles to read, the user can read a daily newsletter and then click through to some of the articles.

The system can generate an effective newsletter by curating the newsletter to the specific audience and having a voice associated with the brand of the publisher. The system, using machine-learned models, can determine a subset of content items (e.g., featured articles) from a plurality of content items (e.g., all of the articles published on the publisher's website). The system can tailor the featured articles in the newsletter for a specific user or groups of users. Additionally, the voice of the newsletter can provide a sense of personality that is associated with the publisher. The newsletter, which is typically received in a user's inbox, can have a more personalized feel when the system generates the newsletter specific for that user.

According to some embodiments, the system can include an information retrieval system that fetches content items from a specific publisher. Additionally, the system can include a classification layer that classifies the content items by classifying the content items with one or more attributes. In some instances, the system can obtain all of the content items from a website associated with the publisher. Additionally, once all of the content items are obtained, the system can determine whether the content items are sponsored or non-sponsored. In some instances, the plurality of content items that are determined to be non-sponsored content can be stored in a database of the system. For example, a sponsored content item can be an article that is a paid promotion or commercial for a product. Therefore, the system can filter out all of the sponsored content items, and only store the non-sponsored content items in the database for further processing.

The plurality of content items can include a plurality of example source content datasets. The content items can include a set of facts (e.g., a press release, a fact pattern, a sports box score, experimental research results, a knowledge graph, etc.), a commentary direction (e.g., an editorial perspective, a theory, a logic string, etc.), and/or other topic information. The content items may be associated with different topics and may include publisher-specific attributes, which may include a specific structure, specific terminology, specific tense, a specific tone, and/or other publisher-specific attributes. A generative model can process and content items to generate a model-generated summary with one or more model-generated attributes.

Content items of different domains (e.g., topic, fields of expertise) can have a publisher-specific structure, style, terminology, tone, and/or other attributes. For example, news articles can include an opening sentence and/or paragraph that includes an overview of a key aspect of a story (e.g., the most important aspect of a story, which can include the “who, what, when, where, why, and/or how”). News articles can include a particular tone, particular syntax, particular terminology, and/or other specific attributes. The generative model can be tuned to generate model-generated content items with the specific attributes.

Additionally, the system can rank the plurality of content items. In some instances, the system can determine a plurality of attributes for each content item and rank the content items based on these attributes. One of the attributes can be a recency value that can be determined by the system based on when the content item was published on the publisher's website. For example, the system can index and crawl a website of a publisher. For each article on the publisher's website, the system can determine a publication date. In some instances, the content items can be ranked in reverse chronological order.

Another attribute can be relevance score associated with the content item. The relevance score can be determined by a machine-learned model. For example, the machine-learned model can process user data and the content item to determine a relevance score for the specific user or specific group of users. In another example, the machine-learned model can process the content item to determine a relevance score for a specific topic. The specific topic can be sports, weather, global news, local news, business, and so on. In some instances, the relevance score can be determined by the machine-learned model by processing a search result score of the content item, user data of the audience, recency value, and/or topic of the newsletter. The search result score can be calculated based on the content item relevancy to a search query.

Each content item of a publisher can be grouped in different categories based on the attributes. For example, all of the sports articles can be grouped in the sport category. Additionally, the sport articles can be ranked and ordered within the sport category. For example, the top ranked sport article can be a featured article in the newsletter. Additionally, the newsletter can be generated specifically for a specific user. For example, articles that are related to golf can have a higher relevancy score when the system determines that the specific user clicks on the golf articles of the newsletter. Thus, the newsletter can be tailored to a specific user or group of users (e.g., users who play golf). By leveraging the machine-learned model, the techniques described herein can enable the system to generate a personalized newsletter for each individual user.

Moreover, the system, using a machine-learned model, can generate a summary (e.g., editorial summary) for the content item (e.g., article). The summary can be personalized for the user based on the user data. Additionally, the summary can be generated, based on the publisher data, with a specific voice to stimulate (e.g., mimic) the tone and style of the publisher.

Furthermore, the system can generate a plurality of newsletters that is tailored to a specific user or groups. Additionally, the system can generate a plurality of newsletters that is tailored to a specific topic (e.g., sports enthusiasts, politics).

In some implementations, the newsletter can be provided with one or more call-to-action banners. The one or more call-to-action banners can include a header, a subtitle, a body paragraph, a selectable action user interface element, and/or an image. The one or more call-to-action banners can be generated by leveraging one or more generative models. For example, a user may provide a prompt to one or more generative models to generate a header, a subtitle, a body paragraph, and/or a selectable action user interface element for a given purpose (e.g., a calendar event RSVP action, a donation action, a website navigation action). The image and/or other media content item for the one or more call-to-action banners may be generated with an image generation model (e.g., a diffusion model) that may generate the image based on the prompt, the generated text, and/or the newsletter that the one or more call-to-action banners are being provided with for the given instance.

The call-to-action banners can be generated then paired with different newsletters based on the contents of the newsletters, recipients of the newsletters, and/or other context details. In some implementations, the image for a banner may be dynamic such that an image in a banner may differ based on which newsletter the banner is provided with for the given transmittal instance. The dynamic image change can be based on generating an image based on the newsletter contents instead of the contents currently in the banner.

The systems and methods of the present disclosure provide a number of technical effects and benefits. As one example, the system and methods can be utilized to tune a generative model and/or guide generative model content item generation. In particular, the systems and methods disclosed herein can leverage a publisher-specific training dataset and one or more evaluation signals to tune a pre-trained generative model for generating model-generated content items that include one or more generated attributes.

Another example of technical effect and benefit can include leveraging a serving infrastructure to select a particular model-generated content item, summary, newsletter that may be provided for display to the user. Alternatively and/or additionally, the model-generated content may be further processed to generate a newsletter that is personalized to a specific user, which can then be provided for display to the user. The serving infrastructure can include an application programming interface that is leveraged to facilitate the input data obtainment and transmittal along with obtaining a plurality of content items that are then filtered and/or ranked for selection. The selection may be based on evaluating the content items based on one or more evaluation signals to generate evaluation datasets that may then be leveraged for threshold based filtering and/or ranking.

Another example of technical effect and benefit relates to improved computational efficiency and improvements in the functioning of a computing system. For example, a technical benefit of the systems and methods of the present disclosure is the ability to reduce the computational resources needed for training and/or tuning a generative model for generating high quality outputs for downstream tasks with publisher-specific and user-specific attributes. In particular, the generative language model can be utilized to generate publisher-specific content items that emulate styles, tones, and/or terminology identified as being user/publisher specific. In some implementations, the generative language model and/or one or more soft prompts (e.g., a set of machine-learned parameters that can be processed with the input by the generative language model) can be trained to emulate the tone, style, and/or vocabulary of a particular domain, a particular user, and/or a particular set of users (e.g., a publishing group).

With reference now to the Figures, example embodiments of the present disclosure will be discussed in further detail.

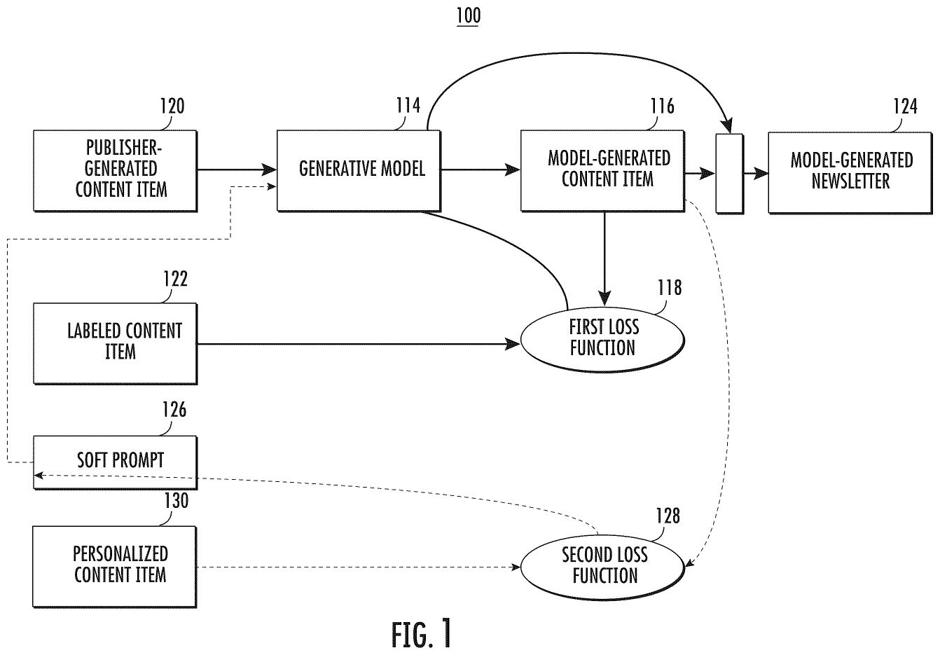

FIG. 1 depicts a block diagram of an example tuning system according to example embodiments of the present disclosure. In particular, the tuning system 100 can obtain a publisher-specific and/or user-specific training dataset. The training dataset may be obtained from a publisher-specific database and/or user database. The publisher-specific database can include content items explicitly submitted by the publisher. The publisher-specific training dataset can include a plurality of labeled content items 122. In some implementations, the plurality of labeled content items 122 can include one or more attributes associated with a particular field of expertise (e.g., news articles (i.e., journalism), research papers (i.e., academia), newsletters, emails, policy bills (i.e., politics)). The training dataset can include a plurality publisher-generated content items 120 associated with the plurality of labeled content items 122. The plurality of labeled content items 122 can include a plurality of new articles (e.g., articles that provide factual information on a news event). The plurality of news articles may include one or more journalistic-specific attributes including the structure, the terminology, and factual pattern layout. In particular, the one or more publisher-specific attributes can include an order of content, which may include a lead before the background information. The lead can summarize a key aspect of a story (e.g., the winner of a race, the outcome of a sporting event, the overall statistics on damage by a natural disaster) in an opening sentence and/or paragraph. The plurality of publisher-generated content items 120 can include a plurality of press releases associated with the plurality of news articles. For example, the plurality of press releases can be a brief statements of facts on respective stories (e.g., statistics, context information including location and/or time, key individuals of note), and the plurality of news articles can include full length news articles that include at least a subset of the facts of the brief statements of facts on respective stories.

The plurality of publisher-generated content items 120 can include a plurality of example source content datasets. The plurality of example source content datasets can include a set of details that may be the basis for content generation. The plurality of example source content datasets may include press releases, interview transcripts, experimental data, blog posts, fact patterns, speeches, and so on.

The tuning system 100 can process a publisher-generated content item 120 with a generative model 114 to generate a model-generated content item 116. Alternatively and/or additionally, the generative model 214 may process an input prompt to generate the model-generated content item 216 (e.g., a model-generated draft of a news article). The input prompt may not be part of the publisher-specific training dataset. The input prompt may include a real world source content example, a synthetic source content example, a freeform text prompt, and/or a few-shot example. The generative model 214 can include a pre-trained generative language model (e.g., a large language model) that was pre-trained on a plurality of different natural language processing tasks. The publisher-generated content item 120 may include a set of details associated with one or more topics (e.g., a story, a particular entity, a theory, etc.). The model-generated content item 216 can include one or more particular attributes (e.g., a particular style, a particular tone, a particular structure, a particular dialect, etc.). Additionally and/or alternatively, the model-generated content item 216 can include a plurality of predicted word sequences (e.g., predicted phrases, sentences, and/or paragraphs) that includes at least a subset of the set of details of the input example and a plurality of words predicted to be associated with the set of details and/or the one or more topics.

The tuning system 100 can then evaluate a first loss function 118 based at least in part on the model-generated content item 116 and a respective labeled content item 122 associated with the publisher-generated content item 120. The first loss function 118 may generate a gradient descent based on comparing the model-generated content item 216 and a respective labeled content item 120. In particular, the first loss function 118 may include penalization terms based on differences between the one or more particular attributes (e.g., the style, structure, tone, and/or terminology of the model-generated content item 116) and the one or more publisher-specific attributes (e.g., the style, structure, tone, and/or terminology of the labeled content item 120).

Additionally and/or alternatively, the first loss function 118 may include penalization terms based on one or more signals associated with the model-generated content item 116. In some implementations, the first loss function 118 can evaluate the accuracy of facts within the model-generated content item 116, the properness of source attribution, the likelihood of plagiarism, the length, the reasoning behind arguments (e.g., whether a theme and/or direction is backed by facts), and/or other signals. The first loss function 118 may include a plurality of loss terms and/or a plurality of loss functions.

One or more parameters of the generative model 114 can then be adjusted based on the first loss function 118. For example, the gradient descent may be back propagated to the generative model 114 to tune weights of the generative model 114 for publisher-specific content generation. The process can be iteratively performed to tune the generative model 114 to generate content items that include the publisher-specific attributes (e.g., to generate news articles with journalistic style, news article structure (e.g., beginning with a lead), active voice, and/or journalistic terminology).

Additionally and/or alternatively, the tuning system 100 may leverage one or more soft prompts 126 for conditioning the generative model 114 for publisher-specific and/or user-specific content generation. In particular, the one or more soft prompts 126 can include a set of tunable parameters (and/or a set of tunable weights). The one or more soft prompts 126 can include computer-readable, machine-learned vector representations. The one or more soft prompts 126 can be stored in association with a particular user (and/or sets of users).

For example, the soft prompt 126 can be tuned based on user-specific attributes (e.g., a user style, a user tone, and/or a user vocabulary (which may include slang and/or a particular word choice)). The soft prompt 126 and the publisher-generated content item 120 can be processed together by the generative model 114 to generate a model-generated content item 116 that includes the set of details from the publisher-generated content item 120 and the user-specific attributes (as conditioned based on the soft prompt 126).

The soft prompt 126 can be tuned and/or trained (or learned) by evaluating a second loss function 128 to generate a gradient descent that can then be back propagated to adjust one or more parameters (and/or weights) of the soft prompt 126. The second loss function 128 may adjust the one or more parameters of the soft prompt 126 to train the soft prompt 126 to condition the generative model 114 to generate model-generated content items that include user-specific attributes (e.g., emulates the style, tone, and/or vocabulary of the user). The second loss function 128 can be evaluated by comparing the attributes of the model-generated content item 116 and the user-specific content item 130.

A tuned generative model 114 (e.g., a fine-tuned publisher-specific generative model) and/or a tuned soft prompt 126 may then be utilized for model inference. Source content and/or the soft prompt 126 can be processed with the generative model 114 to generate a publisher-specific model-generated content item 116. The publisher-specific model-generated content item 216 may emulate the structure, style, tone, and/or terminology of content items within the particular domain. The publisher-specific model-generated content item 116 may then be provided for display to the user.

Alternatively and/or additionally, the model-generated content item 116 may then be processed with the generative model 114 to generate a model-generated outline 124. The model-generated outline 124 can be descriptive of the content within the model-generated content item 116 including the topics, subtopics, theme, and/or order. The model-generated outline 124 can include key points covered by the model-generated content item 216. The model-generated outline 124 may then be provided for display to the user. A user may interact with the model-generated outline 124 to generate an augmented outline. The augmented outline can then be processed by the generative model 214 to generate an updated model-generated content item. The updated model-generated content item may be provided to the user.

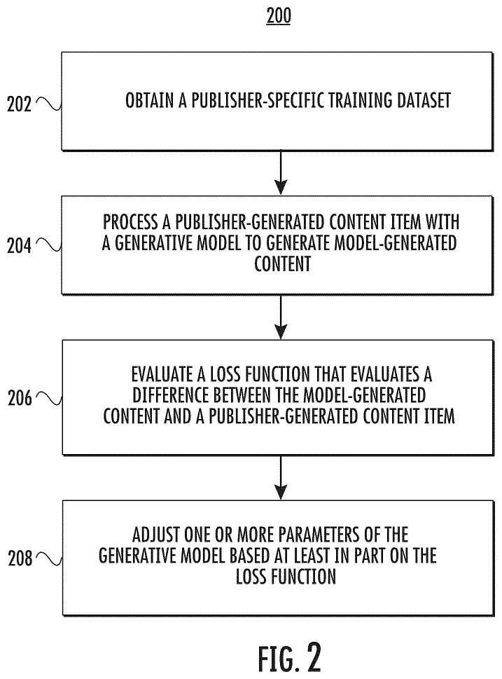

FIG. 2 depicts a flow chart diagram of an example method to perform according to example embodiments of the present disclosure. Although FIG. 2 depicts steps performed in a particular order for purposes of illustration and discussion, the methods of the present disclosure are not limited to the particularly illustrated order or arrangement. The various steps of method 300 can be omitted, rearranged, combined, and/or adapted in various ways without deviating from the scope of the present disclosure.

At 202, a computing system can obtain a publisher-specific training dataset. The publisher-specific training dataset can include a plurality of publisher-generated content items (e.g., a plurality of news articles). In some implementations, the plurality of publisher-generated (e.g., publisher-specific) content items can include one or more publisher-specific attributes associated with a particular field of expertise (e.g., a plurality of news articles with one or more publisher-specific attributes associated with the field of journalism (e.g., news articles)). The one or more publisher-specific attributes can include a particular information structure, and a set of particular stylistic characteristics associated with a particular publication type for the particular field of expertise (e.g., the one or more publisher-specific attributes may include a particular news article information structure and a set of particular news article stylistic characteristics). The publisher-specific training dataset can include a plurality of respective content items associated with the plurality of publisher-specific content items (e.g., a plurality of respective press releases associated with the plurality of news articles). The plurality of publisher-specific content items can include a plurality of new articles. The plurality of news articles may include one or more journalistic-specific attributes including the structure, the terminology, and factual pattern layout. In particular, the one or more publisher-specific attributes can include an order of content, which may include a lead before the background information. The lead can summarize a key aspect of a story in an opening sentence and/or paragraph. The plurality of input examples can include a plurality of press releases (and/or enrichment materials (e.g., interview transcripts)) associated with the plurality of news articles. For example, the plurality of press releases can be a brief statement of facts on respective stories, and the plurality of news articles can include full length news articles that include at least a subset of the facts of the brief statements of facts on respective stories.

In some implementations, the publisher-specific training dataset can include a plurality of publisher-specific content items of a particular publication type. The particular publication type can include a news article type, a research paper type, a newsletter type, an email type, and/or other publication type. The plurality of publisher-specific content items of the particular publication type can include the particular information structure, and the set of particular stylistic characteristics associated with the particular publication type for the particular field of expertise. The particular information structure can include an inverted pyramid structure for news article types. For example, the news article can begin with the who, what, when, where, why, and how of the story (e.g., the most newsworthy information). The news article can then include important details that provide additional key details associated with the who, what, when, where, why, and how of the story. Other lesser details can then be included after the additional key details. The particular information structure for scientific research papers can include a high-level abstract, then an introduction, then related works, then a discussion of the discovery including the researcher's method, then experimental data, and then a conclusion. The particular information structure for a newsletter can include a title, a greeting, an introduction, and a list of pertinent topics.

In some implementations, the set of particular stylistic characteristics associated the particular publication type can include the tone (e.g., a factual tone for news article), particular publication type-specific stylistic name or term use (e.g., news articles write out the full name of a person upon first instance, news articles may limit slang to quotes, and/or news articles may use particular term for a certain occupation, pace, or thing), particular lengths (e.g., news articles may have relatively short sentences and paragraphs, when compared to a literary review of an artistic work), publication type-specific citations (e.g., attribution in news articles can follow different citation style requirements than academic papers or law briefs), and/or other publication type-specific stylistic characteristics.

At 204, the computing system can process a publisher-generated content item with a generative model to generate model-generated content. The publisher-generated content item may include a press release of the plurality of respective press releases. The model-generated content may include a model-generated news article. The model-generated content (e.g., the model-generated news article) can include a plurality of model-generated attributes. In some implementations, the model-generated content can include a model-generated news article (e.g., a model-generated draft of a news article) that includes facts included in the input example (e.g., the example press release). The model-generated content can be generated based on a plurality of sequence predictions. The plurality of model-generated attributes can include the structure, content, terminology, and/or other features of the model-generated content.

At 206, the computing system can evaluate a loss function that evaluates a difference between the model-generated content and a publisher-generated content item. For example, the computing system may evaluate differences between the model-generated news article and a respective news article of the publisher. In some implementations, the loss function can evaluate semantic differences between the model-generated content (e.g., the model-generated news article) and a publisher-specific content item of the plurality of publisher-specific content items (e.g., a respective news article from the publisher-specific training dataset). The loss function can evaluate factual grounding of the model-generated content associated with details from the input example. For example, the loss function may evaluate factual grounding of the model-generated news article associated with details from the press release and/or one or more interviews. In some implementations, the loss function can evaluate the appropriateness of the content, which may include a penalization term for profanity, abusive content, vulgarity, and/or other inappropriate content. Additionally and/or alternatively, the loss function can evaluate a length of the model-generated content, which may include evaluating sub-lengths of the lead, the background information, the additional context, the headline, the subtitle, and/or other sections. In some implementations, the loss function can evaluate correct recitation, proper attribution, and/or a level of verbatim usage. The recitation can be evaluated based on determining if the recitation in the model-generated content properly recites the quote and/or facts of the input example. The attribution can be evaluated based on whether the source(s) are properly cited in the model-generated content. The level of verbatim usage can be determined based on a level of verbatim usage of phrases, sentences, etc. by the model-generated content with respect to the input example and the respective publisher-specific content item. The factual grounding, appropriateness, length, correct recitation, proper attribution, and/or a level of verbatim usage may be evaluated based on one or more respective penalization terms that may be part of the loss function. Alternatively and/or additionally, the factual grounding, appropriateness, length, correct recitation, proper attribution, and/or a level of verbatim usage may be separate loss functions. In some implementations, the loss function can evaluate the plurality of model-generated attributes based on the particular information structure and the set of particular stylistic characteristics associated with the particular publication type (e.g., the particular news article information structure and the set of particular news article stylistic characteristics). Alternatively and/or additionally, the loss function may include one or more penalization terms for penalizing deviation from the particular information structure and/or the set of particular stylistic characteristics associated with the particular publication type.

At 208, the computing system can adjust one or more parameters of the generative model based at least in part on the loss function. The adjustment may be leveraged to tune the generative model for publisher-specific usage (e.g., news article generation, newsletter generation, and/or other domains). Alternatively and/or additionally, parameters (e.g., weights of a set of parameters) of a soft prompt can be tuned based on the loss function.

In some implementations, the computing system can obtain a publisher-specific dataset. The publisher-specific dataset can include a plurality of publisher content item examples. The computing system can generate an additional model-generated content item with the generative model. The additional model-generated content item can include one or more attribute features. The computing system can evaluate a second loss function that evaluates a difference between the additional model-generated content item and one or more of the plurality of publisher content item examples and adjust parameters of the generative model based at least in part on the second loss function. Alternatively and/or additionally, the second loss function may be utilized to tune parameters of a soft prompt. The soft prompt can then be stored for future use by the particular user. The second loss function and the loss function may differ. Alternatively and/or additionally, the second loss function and the loss function may be similar.

In some implementations, evaluating the second loss function that evaluates the difference between the additional model-generated content item and the one or more of the plurality of publisher content item examples can include comparing the one or more attribute features of the additional model-generated content item and one or more ground truth features of the one or more of the plurality of publisher content item examples. The one or more ground truth features can include stylistic attributes associated with a publisher-specific style. The one or more ground truth features can include terminology attributes associated with a publisher-specific vocabulary.

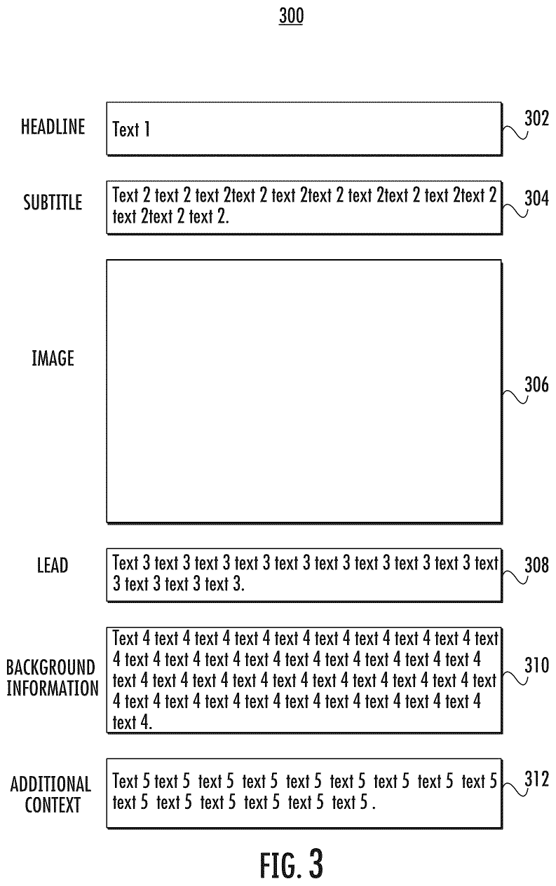

FIG. 3 depicts an illustration of an example news article structure 500 according to example embodiments of the present disclosure. The domain of journalism (e.g., news articles) can have a particular structure. In particular, news articles can have a news article structure 300 that follows a reverse pyramid structure. The reverse pyramid structure can include beginning with the most important information that the reader needs to know, while the level of importance of the information declines as the news article goes on. More specifically, the key information from the story may be provided in the lead 308 of the news article, which may be the first part of the news article. The information that follows in the background information 310 and the additional context 312 may include more detailed information on the key information. For example, the lead 308 may include the who, what, where, when, why, and/or how of the story, while the background information 310 and the additional context 312 provide additional details and context supporting the information included in the lead 308.

The news article structure 300 can further include a headline 302, a subtitle 304, and/or a media content item 306 (e.g., an image). The headline 302 and/or the subtitle 304 may draw the reader in by including information on the topic of the news article and may include a hook. The media content item 306 can include a visual that supports and/or complements the information provided in the news article.

The generative model disclosed herein can be tuned to generate content items that include this news article structure 300, which may include language generation tasks and/or image generation tasks.

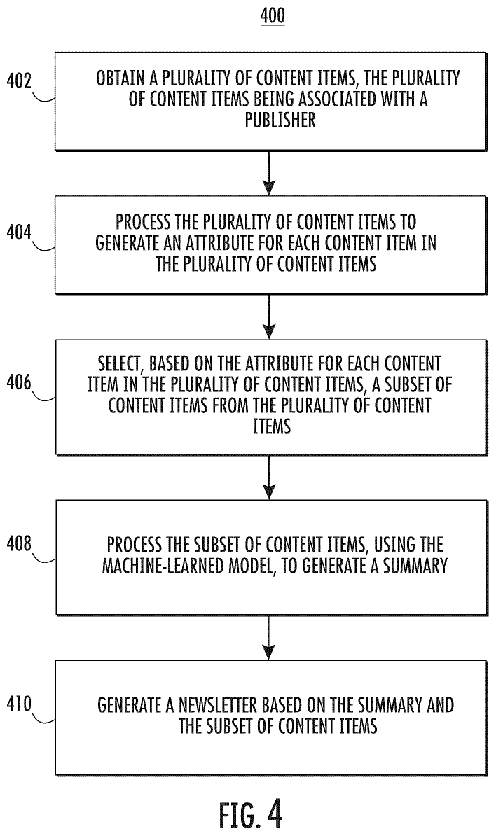

FIG. 4 depicts a flow chart diagram of an example method to perform according to example embodiments of the present disclosure. Although FIG. 4 depicts steps performed in a particular order for purposes of illustration and discussion, the methods of the present disclosure are not limited to the particularly illustrated order or arrangement. The various steps of method 400 can be omitted, rearranged, combined, and/or adapted in various ways without deviating from the scope of the present disclosure.

In some instances, the system can fetch a first content item (e.g., publisher-generated content item) from a server of the publisher. Additionally, the system can determine that the first content item is a non-sponsored content item. Furthermore, the system can store the first content item in the database to be included in the plurality of content items.

At 402, a computing system can obtain a plurality of content items that are associated with a publisher. The plurality of content items can be publisher-generated content items. In some instances, the system can include a database storing the plurality of content items. Additionally, the system can include a machine-learned model that is configured to generate the newsletter.

The plurality of content items may include a press release, one or more interview transcripts, a set of facts, research data, and/or other source content. The plurality of content items can include details associated with a particular topic. The particular topic can include an event, a set of events, and/or other topics. The plurality of content items may include one or more sources associated with the publisher. For example, a first source can be a website of the publisher, a second source can be a social media account of the publisher, a third source can be a mobile application of a publisher.

In some instances, the database can include a plurality of newsletter templates. The system can select, based on the subset of content items, a first template from the plurality of newsletter templates. The newsletter can be generated at operation 408 using the selected template.

At 404, the system can process the plurality of content items to generate an attribute for each content item in the plurality of content items. In some instances, the plurality of content items are processed by the machine-learned model to generate a plurality of attributes for each content item in the plurality of content items.

For example, the attribute can be a relevance score for a specific topic, a relevance score for a specific user, a relevance score for a specific group of users, topicality information (e.g., can be associated with a specific topic), recency information (e.g., associated with a publication date), a popularity score, and so on. The popularity score of a content item can be calculated based on page views of the content item, bounce rate of the content item, click-through rate (CTR) of the content item link in the newsletter, and other metrics associated with how popular the content item is to readers.

At 406, the system can select, based on the attribute for each content item in the plurality of content items, a subset of content items from the plurality of content items. For example, the subset of content items can be featured (e.g., top-ranked) articles of the publisher.

In some instances, the system can obtain user data associated with a first user. Additionally, the system can select the subset of content items from the plurality of content items based on the user data. In one embodiment, the system can generate the newsletter based on the user data. For example, the system, using a machine-learned model, can process the user data and the subset of content items to generate the newsletter.

In some instances, the selecting of the subset of content items from the plurality of content items can include determining a relevance score for each content item in the plurality of content items based on the plurality of attributes for each content item in the plurality of content items. Additionally, the system can rank each content item in the plurality of content items based on the relevance score for each content item. The subset of content items can be selected based on the ranking of each content item.

In some instances, the system can obtain group data associated with a first group of users. Additionally, the system can select the subset of content items from the plurality of content items based on the group data. Moreover, the system can determine a first template for the newsletter based on the group data. Furthermore, the system can generate the newsletter at operation 408 for the first group of users using the first template.

In some instances, the first template can have a content plan that is determined based on the group data. Additionally, the first template can have a content structure that is determined based on the group data.

At 408, the system can generate a newsletter based on the summary and the subset of content items. In some instances, the system can process the subset of content items and the user data, using the machine-learned model, to generate the summary. Additionally, the system can generate the newsletter using the summary, the subset of content items, and the user data.

In some instances, the system can determine a voice of the publisher, the voice of the publisher having a specific tone. Additionally, the system can process, using the machine-learned model, the voice of the publisher, the summary, and the subset of content items to generate the newsletter.

Furthermore, the system can transmit the newsletter to an email account associated with the first user. In some instances the newsletter is transmitted at a first time interval, and wherein the first time interval is based on user data.

In some instances, the system can obtain weather data associated with a location of a specific user. Additionally, the system can process, using the machine-learned model, the weather data and the subset of content items to generate the summary. The newsletter can be personalized for the specific user.

In some instances, the system can determine trend data based on interest of similar users. Additionally, the system can process, using the machine-learned model, the trend data, the summary, and the subset of content items to generate the newsletter.

In some instances the system can receive user input associated with a selected content item in the newsletter. Additionally the system can update a parameter of the machine-learned model, based on the user input. The system can adjust one or more parameters of the generative model based at least in part on the loss function. The parameter adjustment may be based on a gradient descent generated by the one or more loss functions. The parameter adjustment may include freezing a subset of the parameters of the generative model and adjusting at least a portion of the non-frozen parameters.

In some instances, the system can generate an updated newsletter, wherein the updated newsletter is generated based on the user input associated with the selected content item.

In some instances, can provide the newsletter for display. Additionally, the system can receive user input. The user input may be associated with a request to edit the information, order, and/or structure of the outline. Moreover, the system processes the user input to generate an updated newsletter and/or update a template for a newsletter. The updated newsletter can include an updated summary and updates to the subset of content items selected at operation 406.

In some implementations, the computing system can provide the updated newsletter for display. The updated newsletter may be provided for display via the graphical user interface. The updated newsletter may include an updated news article, an updated newsletter, an updated email, and/or other updated model-generated content.

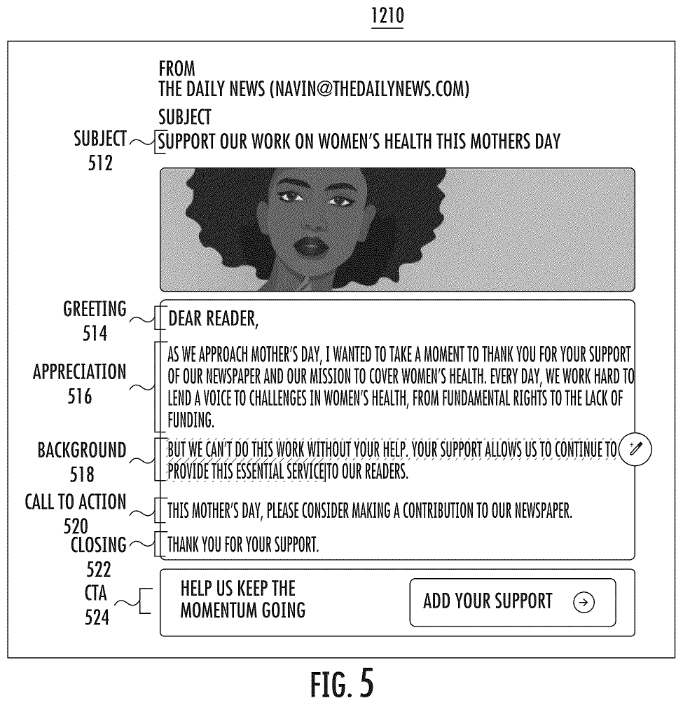

FIG. 5 depicts an illustration of an example newsletter 510 according to example embodiments of the present disclosure. In particular, the domain may be associated with emails (e.g., business and/or fundraiser focused emails). The model-generated content item can include an email. The email structure can include a subject line 512 of the email, a greeting line 514, an appreciation section 516 (e.g., an introduction paragraph), a background section 518, a call to action section 520, a closing section 522, and/or an interactive interface element 524. For example, the model-generated content-item can be generated to have a traditional email structure that may have variances based on the type of email and/or the user. The interactive interface element 524 can be a selectable interface element to perform one or more actions, which may include navigating to a web portal.

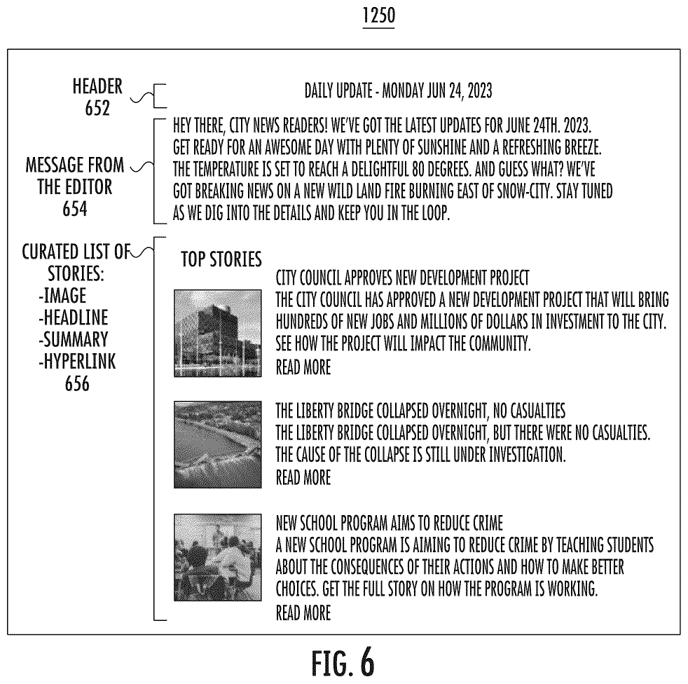

FIG. 6 depicts an illustration of an example newsletter 650 according to example embodiments of the present disclosure. In particular, the domain may be associated with newsletters. For example, news articles, article headlines, article leads, and/or news blurbs may be submitted by a publisher and/or other user to the generative model to generate a newsletter 650. The newsletter structure can include a header 652 descriptive of a time, a location, a topic, and/or other context of the newsletter 650. The newsletter structure can include a message from the editor 654, which may include a newsletter introduction, primer, summary, and/or preface. The newsletter structure can then include a curated list of stories 656, which may be indicated by story headlines, story summaries, story image thumbnails, and/or story hyperlinks.

The system can include a serving infrastructure that can be leveraged to determine and/or facilitate the generation of publisher-generated content items that can be evaluated to determine a particular publisher-generated content item to provide to a user. The system can include a publisher-specific generative model system to be utilized by news publishers (e.g., local and/or regional newspapers) to quickly generate news articles from press releases, while maintaining journalistic style, terminology, and structure. The publisher-specific generative model system may be leveraged for other publisher-specific content generation (e.g., email campaigns, newsletters, speeches, marketing reports, etc.). A serving infrastructure can be utilized to evaluate and filter model-generated content items, generate outlines for user-evaluation and customization, and generate updated model-generated content items.

News articles and other specialized areas can have specific stylization, terminology, processes, and/or structure to their content items. Large language models can generate detailed content items; however, the content items may fail to have the publisher-specific features. Additionally, different publishers may have varying styles, terminologies, and/or other signature features that may be lost via the use of traditional large language models. Moreover, large language models can suffer from hallucinations and may provide plagiarism concerns.

The system can be implemented to interface with publisher-specific generative models to obtain, filter, and rank model-generated content items to determine particular model-generated content items to provide to a user. Additionally, the system may include models for generating outlines and/or processing user-provided customization inputs. Application programming interfaces can be utilized for interfacing with generative models and user-facing platform features. Quality signals including abusive content signals, factual grounding signals, recitation signals, verbatim signals, attribution signals, and length signals can be determined for the candidate content items, which can then be leveraged for the filtering and/or ranking.

The system can facilitate the content item generation, which can include filtering content items based on content attributes that are publisher-specific. For example, length, attribution, and factual grounding thresholds may vary from domain to domain. Additionally, the system can be leveraged to determine which model and/or model-output to utilize for specific tasks based on output evaluations.

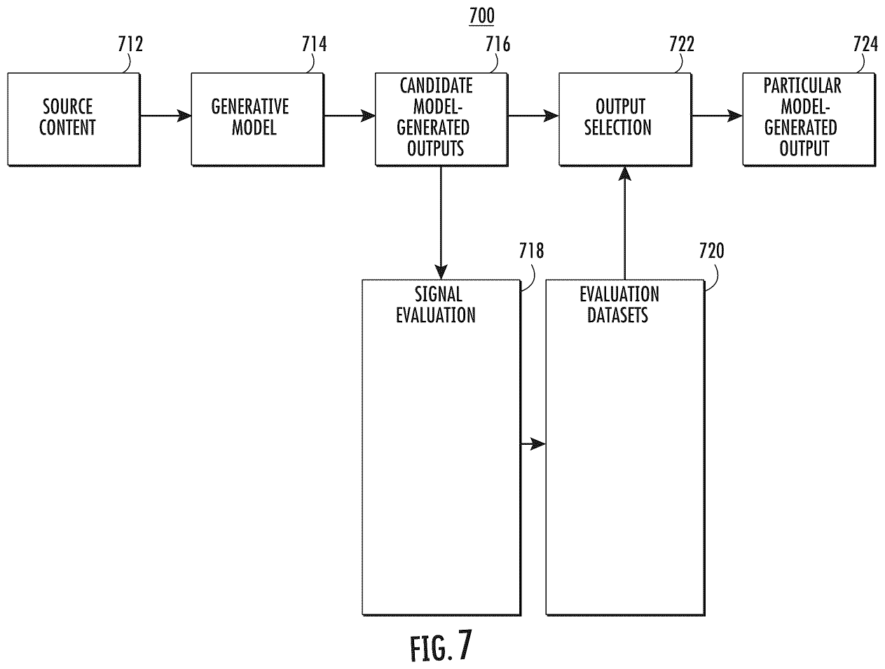

FIG. 7 depicts a block diagram of an example candidate model-generated content item selection system 700 according to example embodiments of the present disclosure. In particular, the candidate model-generated content item selection system 700 can process the source content 712 with one or more generative models 714 to generate a plurality of candidate model-generated outputs 716. The plurality of candidate model-generated outputs 716 can then be processed to perform signal evaluation 718 for the plurality of candidate model-generated outputs 716 to generate a plurality of respective evaluation datasets 720. The plurality of respective evaluation datasets 720 can then be utilized for output selection 722 to select a particular model-generated output 724 to provide to the user computing system.

For example, the candidate model-generated content item selection system 700 can obtain source content 712. The source content 712 can include a set of details to be leveraged to generate a longform publisher-specific content item. The source content 712 can include a press release, interviews, experimental data, a set of news articles, a fact pattern, and/or other source information.

The source content 712 can be processed to select one or more particular generative models 714 to utilize. For example, the source content 712 can be processed to determine one or more tasks associated with the source content 712. One or more particular generative models 714 of a plurality of candidate generative models may be determined based on the one or more tasks. The plurality of candidate generative models can include a plurality of publisher-specific generative models that may perform differently on different tasks. In particular, the plurality of candidate generative models may have different configurations, different training datasets, different tuning datasets, and/or different sizes.

The one or more generative models 714 can process the source content 712 to generate a plurality of candidate model-generated outputs 716 (e.g., a plurality of candidate model-generated content items). The plurality of candidate model-generated outputs 716 (e.g., a plurality of draft publisher-specific content items) can include a plurality of model-generated news articles, a plurality of model-generated research papers, a plurality of model-generated newsletters, a plurality of model-generated emails, and/or a plurality of other publisher-specific model-generated content items.

The plurality of candidate model-generated outputs 716 can then be evaluated via signal evaluation 718. For example, each of the plurality of candidate model-generated outputs 716 can be evaluated for inappropriateness, factual grounding, length, recitation, attribution, verbatim, and/or other quality signals. The inappropriateness can be associated with profanity, sensitive topics, pornography, private information, legality, gore, and/or other appropriateness factors. The factual grounding can be determined based on whether facts in the candidate model-generated outputs 716 have factual grounding in the source content 712 and/or other factual resources. The length can be determined based on a range associated with the particular domain. The recitation can be determined based on quotes and/or other direct recitations are accurately recited. The attribution can be based on the accuracy and/or appropriateness of attributions (e.g., quote attributions, resource citations, etc.). The verbatim can be determined based on a determined level of verbatim inclusion of content. For example, a likelihood of plagiarism may be determined.

The signal evaluation 718 can be performed to generate a plurality of evaluation datasets 720. Each of the plurality of evaluation datasets 720 can include a plurality of signal values associated with a respective candidate model-generated output. Each evaluation dataset 720 can include an inappropriateness value, a factual grounding value, a length value, a recitation value, an attribution value, a verbatim value, and/or other quality signal values.

The plurality of evaluation datasets 720 can then be processed to perform output selection 722. The output selection 722 can include filtering and/or ranking. For example, the candidate model-generated outputs may be filtered to filter out candidate model-generated outputs that do not meet one or more thresholds (e.g., each value may have a threshold value). In some implementations, the output selection 722 may include ranking the plurality of candidate model-generated outputs 716 based on the plurality of respective evaluation datasets 720.

The output selection 722 can be performed to determine a particular model-generated output 724 to provide to the user computing system as output. Alternatively and/or additionally, the particular model-generated output 724 may be processed to generate a model-generated outline that may then be provided to the user computing system.

FIG. 16 depicts a block diagram of an example infrastructure system 800 according to example embodiments of the present disclosure. The infrastructure system 800 can process source content to select one or more publisher-specific generative models 806, which can then be utilized to process the source content to generate a plurality of candidate model-generated outputs (e.g., model-generated content items and/or model-generated outlines) that may then be evaluated to select a particular model-generated output to provide to the user.

In particular, the infrastructure system 800 can include features 802 for generating outlines 824, articles, summaries, newsletters, social posts, business campaigns, and/or other content items. The infrastructure system 800 can include a serving infrastructure 804 for handling the input data obtainment, processing, output generation, output selection, and/or output transmission. The infrastructure system 800 can include a plurality of different publisher-specific models 806 that may be utilized for content generation.

For example, the serving infrastructure 804 can leverage a generative application programming interface 808 to obtain input data and facilitate the output generation and/or processing. In particular, the generative application programming interface 808 can instruct a generative request handler 810 to have a model-serving/adapter 812 interface with one or more domain specific models 806, which may include a server stored model 814 and/or a cloud stored model. The one or more particular publisher-specific models 806 may be selected for the content generation. The one or more domain specific models 806 can include a first language model, a second language model, a multimodal language model, and/or an image generation model. The one or more particular publisher-specific models 806 can process the source content to generate a plurality of candidate model-generated outputs. The generation may be limited to a certain number of candidate model-generated outputs (e.g., eight).

The generative request handler 810 may facilitate the evaluation of the plurality of candidate model-generated outputs based on a plurality of signals 816. The plurality of signals 816 can include a plurality of online signals, which may include an inappropriateness signal, a grounding signal, a length signal, a recitation signal, an attribution signal, a verbatim signal, and/or other signals. The plurality of candidate model-generated outputs (and/or variants) may then be filtered 818 to filter out candidates that do not meet one or more signal thresholds. The remaining candidate model-generated outputs may then be ranked based on the plurality of signals 816 to select 822 a particular candidate model-generated output (e.g., a top variant).

The generative application programming interface 808 may then transmit the particular candidate model-generated output (e.g., a top variant) to the user computing system for display.

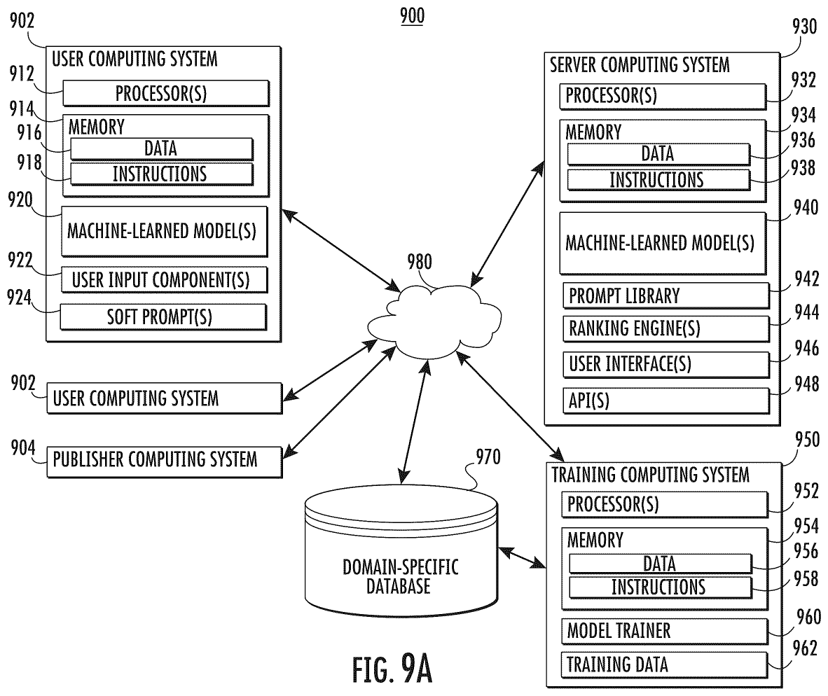

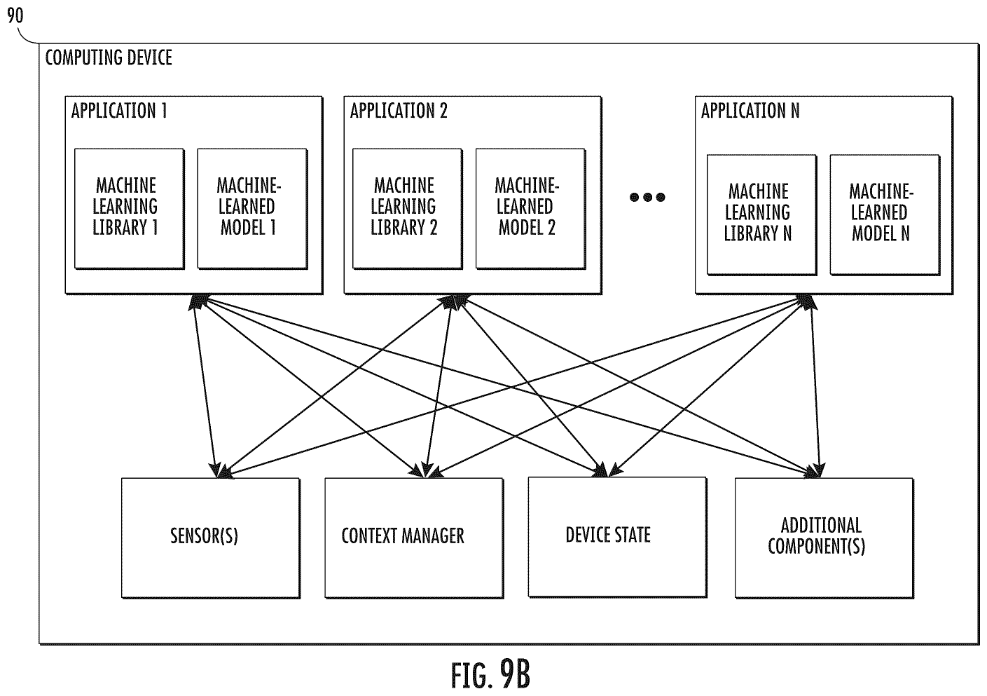

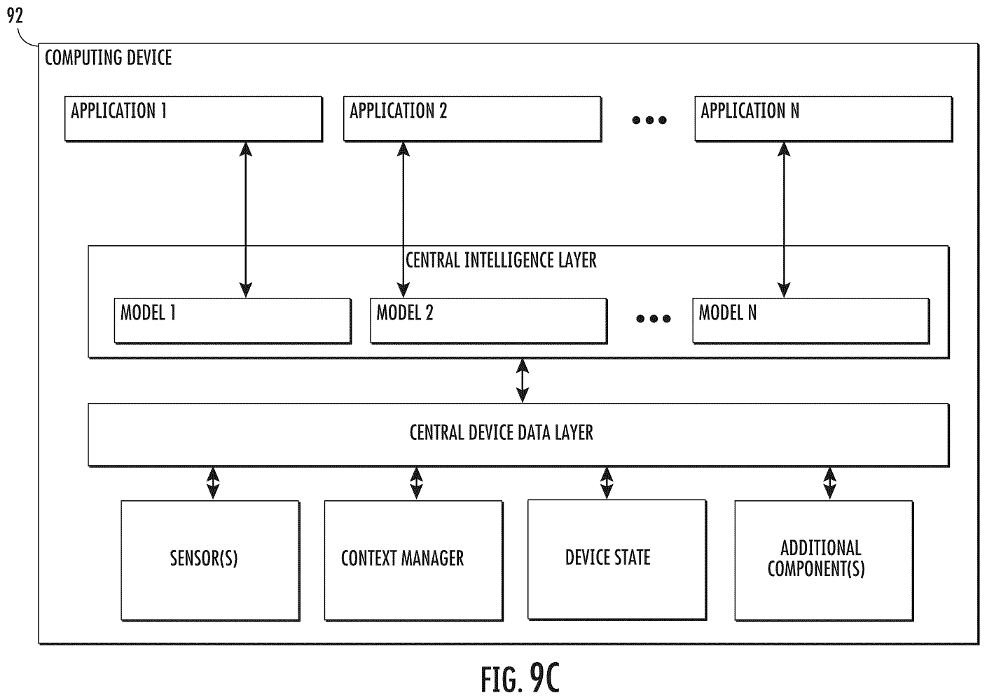

FIG. 9A depicts a block diagram of an example computing system 100 that performs publisher-specific content item generation according to example embodiments of the present disclosure. The system 100 includes a user computing system 102, a server computing system 130, and a training computing system 150 that are communicatively coupled over a network 180. The system 100 can include iterative communications between the user computing system 102, the server computing system 130, and/or the training computing system 150. For example, the user computing system 102 and the server computing system 130 may exchange transmissions upon each instance of content generation. Alternatively and/or additionally, the user computing system 102, the server computing system 130, and/or the training computing system 150 may be utilized to train one or more machine-learned models 120 and/or one or more soft prompts 124 that may then be transmitted and/or stored on the user computing system 102 for off server (and/or offline) content generation.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, an edge computing device, and/or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120 (e.g., machine-learning generative models). For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, and/or other forms of neural networks. The one or more machine-learned models 120 can include one or more feed-forward models, one or more recurrent models, one or more convolutional models, one or more self-attention models, one or more transformer models, and/or one or more other models. The one or more machine-learned models can include different layers, blocks, sub-models, and/or models in one or more configurations, which can include parallel processing, processing in series, bypass processing, recurrent processing, and/or a mixture of approaches. The one or more machine-learned models 120 can include pre-trained generative models that are then tuned based on a publisher-specific training dataset. The one or more generative models may include one or more transformer models. In some implementations, the one or more generative models can include a large language model (e.g., a foundational model, a vision language model, etc.), an image generation model (e.g., a text-to-image model, an audio generation model, and/or one or more other data generation models. The one or more generative models may include an autoregressive language model and/or a diffusion model. Example machine-learned models 120 are discussed with reference to FIG. 1-4, 7-10, 15-16, & 18-20.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel publisher-specific content item generation across multiple instances of input/obtained source content).

More particularly, the machine-learned model 120 can be trained and/or tuned for publisher-specific content generation (e.g., a publisher-specific generative model). The publisher-specific content generation model can process input data to generate one or more publisher-specific model-generated content items. The input data can include source content that can provide details (e.g., facts and/or a theme) that can be leveraged by the generative model to generate the one or more publisher-specific model-generated content items. The domain may include news articles, research papers, newsletters, and/or another field of expertise. For example, a pre-trained generative model may be tuned to generate news articles based on press releases (e.g., the source content may be the press release, and the publisher-specific model-generated content item may be a model-generated news article).

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a publisher-specific content item generation service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the computing system 100 may utilize one or more soft prompts 124 for conditioning the one or more machine-learned models (120 and/or 140) for downstream tasks. The one or more soft prompts 124 can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual and/or one or more entities such that the output is tailored for that particular individual and/or particular entities. The one or more soft prompts 124 can be obtained and processed with one or more inputs by the one or more machine-learned models (120 and/or 140).

The one or more soft prompts 124 can include a set of machine-learned weights. In particular, the one or more soft prompts 124 can include weights that were trained to condition a generative model to generate model-generated content items that emulate a style, tone, and/or vocabulary of a user and/or a set of users. For example, the one or more soft prompts 124 can be utilized by a user to generate the style, tone, and/or vocabulary of their manually authored works. The one or more soft prompts 124 can be extended to a plurality of users. For example, a publisher associated with a publication (e.g., a newspaper) may tune the set of parameters on a plurality of their content items to condition the generative model to generate content items that include their style, tone, and/or vocabulary. The one or more soft prompts 124 may include a plurality of learned vector representations that may be model-readable.

A particular soft prompt 124 can be obtained based on a particular user and/or set of users (e.g., members of a particular publishing company (e.g., a newspaper)). The particular soft prompt 124 can include a set of learned parameters. The set of learned parameters can be processed with the generative model to generate the model-generated content item.

The user computing system 102 and/or the server computing system 130 may store one or more soft prompts 124 associated with the particular user. The soft prompt(s) 124 can include a set of parameters. The user computing system 102 and/or the server computing system 130 may leverage the set of parameters of the soft prompt(s) 124 and a machine-learned content generation model to generate a model-generated content item. In some implementations, the model-generated content item can be generated based on the set of parameters associated with the particular user.

The utilization of a soft prompt (i.e., a set of parameters that can be processed with a generative model for downstream task conditioning) can reduce the computational cost for parameter tuning for user-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned content generation model) for particular downstream tasks (e.g., content generation that is associated with a style and/or vocabulary of a user).

In some implementations, the generative language model and/or one or more soft prompts 124 (e.g., a set of machine-learned parameters that can be processed with the input by the generative language model) can be trained to emulate the tone, style, and/or vocabulary of a particular user and/or a set of users to provide content items in terms, tone, styles, and/or dialects that a user traditionally uses.

Machine-learned model(s) 120 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, and/or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

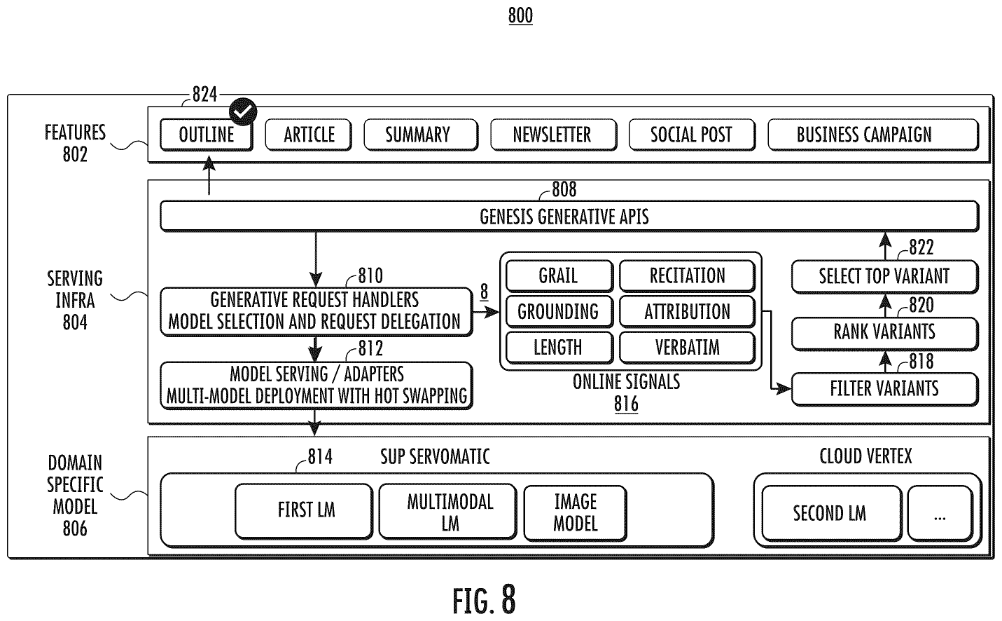

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2, 4, and 7-8.

In some implementations, the server computing system 130 can include a prompt library 142. The prompt library 142 can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the source content to generate a more detailed and complete prompt for the generative model to process. The templates can include text descriptive of the request. The templates may be publisher-specific, user-specific, and/or content-specific. The plurality of prompt templates may include few-shot examples.

The prompt library 142 can store a plurality of soft prompts. The plurality of soft prompts may be associated with a plurality of different domains and/or a plurality of different users. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The server computing system 130 may include one or more ranking engines 144. The one or more ranking engines 144 can include one or more functions and/or one or more machine-learned models. The one or more ranking engines 144 can be configured and/or trained to process a plurality of candidate model-generated content items to generate a ranking of the plurality of candidate model-generated content items based on one or more signals (e.g., a plurality of evaluation signals).

In some implementations, the server computing system 130 can include one or more user interfaces 146 that can be utilized to obtain input data and provide output data to the user computing system 102. The one or more user interfaces 146 can include graphical user interfaces configured to obtain inputs from a user and provide the outputs for display to the user. The one or more user interfaces 146 can include a source content input interface, an outline editing interface, a model-generated content item display interface, and/or one or more other interfaces.

Additionally and/or alternatively, the server computing system 130 may utilize one or more application programming interfaces (API) 148. The application programming interfaces can facilitate input retrieval, generative model interfacing, ranking engine transmissions, and/or other tasks. The application programming interfaces (API) 148 can facilitate the exchange of information between applications, models, computing systems, and/or platforms.

The user computing system 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing system 102 and/or the server computing system 130 using various training or learning techniques, such as, for example, backwards propagation of errors. For example, a loss function can be back propagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, a publisher-specific training dataset that may include a plurality of input examples (e.g., press releases, experimental data, etc.) and a plurality of respective publisher-specific content items. The plurality of respective publisher-specific content items can include example publisher-specific content items (e.g., example news articles, example research papers, etc.). The plurality of publisher-specific content items can include one or more publisher-specific attributes.

Training can include utilizing and/or interfacing with a publisher-specific database 170. The user computing system 102, the server computing system 130, and/or the training computing system 150 may communicate with the publisher-specific database 170 via the network 180. Alternatively and/or additionally, the publisher-specific database 170 may be part of the server computing system 130 and/or the training computing system 150.

The publisher-specific database 170 can store one or more publisher-specific training datasets. The publisher-specific database 170 can include a plurality of content items associated with one or more domains (e.g., one or more fields of expertise (e.g., journalism, physics research papers, literary analysis thesis)). In some implementations, the publisher-specific database 170 can include a plurality of input examples, which can include a plurality of example source content datasets. The publisher-specific database 170 can include real-world content items, curated content items, and/or synthetic content items (e.g., model-generated content items).

The publisher-specific database 170 can be generated based on content item owners (e.g., authors, publishers, and/or assignees) submitting their content items to the database. Users can be given the option on whether their content item is utilized for training and/or tuning. The system 100 can provide users with options on if, when, how, and/or to what extent their content items are utilized. Users can be provided with the option to not provide the content item for storage and/or usage. The publisher-specific database 170 and/or the publisher-specific training dataset can be limited to only input examples and/or content items that are received based on permissions provided by the rights holder of the particular input examples and/or content items. The user may direct the system 100 to only utilize their content during soft prompt tuning. The soft prompts 124 may then be stored on the user computing system 102 and/or the prompt library 142 with restrictions to only be utilized by the particular user. Rights holders and/or users can rescind their permissions, which can then cause the adjustment of if, when, how, and/or to what extent their content is utilized (which may include stopping all storage and/or usage).

The system 100 can leverage evaluation signals, filtering, and/or loss functions to train and/or configure the system to ensure that model-generated content items are not plagiarizing content items from the publisher-specific database 170 and/or the publisher-specific training dataset.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be back propagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the one or more machine-learned models (e.g., 120 and/or 140) can include one or more generative models to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models can be trained to process input data and generate model-generated content items, which may include a plurality of predicted words, pixels, signals, and/or other data. The model-generated content items may include novel content items that are not the same as any pre-existing work. The one or more generative models can leverage learned representations, sequences, and/or probability distributions to generate the content items, which may include phrases, storylines, settings, objects, characters, beats, lyrics, and/or other aspects that are not included in pre-existing content items.

The one or more generative models may include a vision language model. The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models may be stored on-device and/or may be stored on a server computing system. In some implementations, the one or more generative models can perform on-device processing to determine suggested searches, suggested actions, and/or suggested prompts. The one or more generative models may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. Sequence processing models can process one or multiple types of data simultaneously. Sequence processing models can include relatively large models (e.g., more parameters, computationally expensive, etc.), relatively small models (e.g., fewer parameters, computationally lightweight), or both.

In general, sequence processing models can obtain an input sequence using data from inputs. For instance, input sequence can include a representation of data from inputs in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressive. For instance, multiple output elements of the output sequence can be predicted together without explicit sequential conditioning on each other.

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

In some implementations, if the user has provided consent, the training examples can be provided by the user computing system 102. Thus, in such implementations, the model 120 provided to the user computing system 102 can be trained by the training computing system 150 on user-specific data received from the user computing system 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be audio compression. The input may include audio data and the output may include compressed audio data. In another example, the input includes visual data (e.g., one or more images or videos), the output can include compressed visual data, and the task is a visual data compression task. In another example, the task may include generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may include a text output which is mapped to the spoken utterance. In some cases, the task may include encrypting or decrypting input data. In some cases, the task can include a microprocessor performance task, such as branch prediction or memory address translation.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following the task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

FIG. 9A illustrates one example computing system that can be used to implement the present disclosure. Other computing systems can be used as well. For example, in some implementations, the user computing system 102 can include the model trainer 160 and the training dataset 162. In such implementations, the models 120 can be both trained and used locally at the user computing system 102. In some of such implementations, the user computing system 102 can implement the model trainer 160 to personalize the models 120 based on user-specific data.

FIG. 9B depicts a block diagram of an example computing device 90 that performs according to example embodiments of the present disclosure. The computing device 90 can be a user computing device or a server computing device.

The computing device 90 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 9B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 9C depicts a block diagram of an example computing device 92 that performs according to example embodiments of the present disclosure. The computing device 92 can be a user computing device or a server computing device.

The computing device 92 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 9C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 92.

The central intelligence layer can communicate with a central device data layer. The central device data layer can be a centralized repository of data for the computing device 92. As illustrated in FIG. 9C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computing system for generating a newsletter, comprising:
one or more processors; and
one or more non-transitory computer-readable media that collectively store:
a database storing a plurality of content items, the plurality of content items being associated a publisher; and
a machine-learned model, wherein the machine-learned model is configured to generate the newsletter; and
instructions that, when executed by the one or more processors, cause the computing system to perform operations, the operations comprising:
processing the plurality of content items to generate an attribute for each content item in the plurality of content items;
selecting, based on the attribute for each content item in the plurality of content items, a subset of content items from the plurality of content items;
processing the subset of content items, using the machine-learned model, to generate a summary; and
generating a newsletter based on the summary and the subset of content items.

2. The computing system of claim 1, the operations comprising:
obtaining user data associated with a first user;
selecting the subset of content items from the plurality of content items based on the user data;
processing the subset of content items and the user data, using the machine-learned model, to generate the summary; and
generating the newsletter using the summary, the subset of content items, and the user data; and
transmitting the newsletter to an email account associated with the first user.

3. The computing system of claim 1, wherein the newsletter is transmitted at a first time interval, and wherein the first time interval is based on user data.

4. The computing system of claim 1, wherein the plurality of content items are processed by the machine-learned model to generate a plurality of attributes for each content item in the plurality of content items.

5. The computing system of claim 4, wherein the selecting of the subset of content items from the plurality of content items further comprises:
determining a relevance score for each content item in the plurality of content items based on the plurality of attributes for each content item in the plurality of content items;
ranking each content item in the plurality of content items based on the relevance score for each content item, and
wherein the subset of content items are selected based on the ranking of each content item.

6. The computing system of claim 1, the operations further comprising:
obtaining weather data associated with a location of a specific user;
processing, using the machine-learned model, the weather data and the subset of content items to generate the summary, and
wherein the newsletter is personalized for the specific user.

7. The computing system of claim 1, the operations further comprising:
determining trend data based on interest of similar users; and
processing, using the machine-learned model, the trend data, the summary, and the subset of content items to generate the newsletter.

8. The computing system of claim 1, the operations further comprising:
determine a voice of the publisher, the voice of the publisher having a specific tone; and
processing, using the machine-learned model, the voice of the publisher, the summary, and the subset of content items to generate the newsletter.

9. The computing system of claim 1, wherein the attribute is a relevance score for a specific topic.

10. The computing system of claim 1, wherein the attribute is a relevance score for a specific group of users.

11. The computing system of claim 1, wherein the attribute is associated with a topic.

12. The computing system of claim 1, wherein the attribute is associated with a publication date.

13. The computing system of claim 1, wherein the database further includes a plurality of newsletter templates, the operations comprising:
selecting, based on the subset of content items, a first template from the plurality of newsletter template, and
wherein the newsletter is generated using the selected template.

14. The computing system of claim 1, the operations comprising:
obtaining group data associated with a first group of users;
selecting the subset of content items from the plurality of content items based on the group data;
determining a first template for the newsletter based on the group data; and
generating the newsletter for the first group of users using the first template.

15. The computing system of claim 1, wherein the first template has a content plan that is determined based on the group data, and wherein the first template has a content structure that is determined based on the group data.

16. The computing system of claim 1, the operations further comprising:
fetching a first content item from a server of the publisher;
determining that the first content item is a non-sponsored content item; and
storing the first content item in the database to be included in the plurality of content items.

17. The computing system of claim 1, the operations further comprising:
receiving user input associated a selected content item in the newsletter; and
updating, a parameter of the machine-learned model, based on the user input.

18. The computing system of claim 17, the operations further comprising:
generating an updated newsletter, wherein the updated newsletter is generated based on the user input associated with the selected content item.

19. A computer-implemented method, comprising:
obtaining, by a computing system comprising one or more processors, a plurality of content items, the plurality of content items being associated with a publisher;
processing the plurality of content items to generate an attribute for each content item in the plurality of content items;
selecting, based on the attribute for each content item in the plurality of content items, a subset of content items from the plurality of content items;
processing the subset of content items, using the machine-learned model, to generate a summary; and
generating a newsletter based on the summary and the subset of content items.

20. One or more non-transitory computer-readable media that collectively store instructions that, when executed by one or more computing devices, cause the one or more computing devices to perform operations, the operations comprising:
obtaining, a plurality of content items, the plurality of content items being associated with a publisher;
processing the plurality of content items to generate an attribute for each content item in the plurality of content items;
selecting, based on the attribute for each content item in the plurality of content items, a subset of content items from the plurality of content items;
processing the subset of content items, using the machine-learned model, to generate a summary; and
generating a newsletter based on the summary and the subset of content items.
